(19) United States
(12) Patent Application Publication
(10) Pub. No.: US 2006/0033061 A1
(43) Pub. Date: Feb. 16, 2006

(54) Vacuum lock

(76) Inventors: Bart Scholte van Mast, Azmoos (CH); Silvio Jaeger, Mauren (LI)

Correspondence Address: NOTARO AND MICHALOS, 100 DUTCH HILL ROAD, SUITE 110, ORANGEBURG, NY, 10962-2100, US

(21) Appl. No.: 11/181,965

(22) Filed: Jul. 14, 2005

(30) Foreign Application Priority Data
Aug. 13, 2004 (CH) 2004 01342/04

(51) Int. Cl. F16K 35/00

(52) U.S. Cl. 251/93

(57) ABSTRACT

A vacuum lock on a vacuum chamber has a lockable gate opening with a substantially vertical gate and the following characteristics: the gate is a sliding plate displaceable parallel to the opening; the gate is connected via a driving rod on a side oppose the opening and is supported at a distance in the sliding direction; this connection is via a guidance mechanism such that in the presence of a blockage of the closing process, the gate is laterally pressed on a seal encompassing the opening; and a spring element is provided to narrowly compensates the weight of the gate. This ensures that in the event of a operator error or unintentional reaching into the opening during a closing process, injuries cannot occur and a high degree of safety is ensured.

### FIELD AND BACKGROUND OF THE INVENTION

The invention relates to a vacuum lock disposed in a vacuum chamber with a gate opening, disposed substantially vertically and in one plane lockable with a gate, as well as to a method for transporting substrates through the lock into a vacuum chamber.

In automated vacuum process units vacuum locks or valves are utilized for passing substrates to be worked from one atmosphere into the other, such systems, as a rule, being operated pneumatically or electrically. Many such systems utilize gates which are developed as sliding gates, which are slid along a vacuum seal disposed about a gate opening and subsequently is pressed on for sealing. When the sliding gate is open, substrates or also entire cassettes with substrates, for example with semiconductor wafers, can be placed into the vacuum chamber. This introduction of substrates into a vacuum chamber through a lock gate opening is often carried out manually and human personnel extends, for example arms, through the opening plane of the gate configuration. The closing process of the lock gate which thereupon becomes necessary, represents a considerable injury potential for this operation carried out by human personnel. This is in particular the case since the involved operator must extend his hand through the particular gate opening several times within a short period of time through. A defect of the closure system or also an erroneous behavior by the operator can cause correspondingly dangerous conditions and possibly serious injury.

According to prior art such lock configurations are monitored and controlled with the aid of electronic systems. The conventional approach involves that the presence of a hindrance or blockage in the proximity of the gate is detected and consequently the movement of the gate is stopped. As a rule, such systems are complex and expensive and usually do not include the desired high degree of safety, since electronic systems themselves can also be prone to errors. Various important industrial states point out this safety problem and advise appropriately minimizing the safety risks through solutions which are more reliable than complicated electronic monitoring systems.

### SUMMARY OF THE INVENTION

The present invention has as its aim to eliminate the disadvantages of the above described prior art. The aim comprises in particular realizing an economically realizable vacuum lock with a sliding gate disposed substantially vertically, which, if a person accidentally reaches into the gate opening, offers a high degree of protection and safety for this person.

The aim is attained according to the invention through the configuration and the approach according to the characteristics of the independent claim or claims and the dependent claims define further advantageous embodiments.

The problem the invention poses is solved according to the invention thereby that a vacuum lock located on a vacuum chamber is provided with a gate opening disposed substantially vertically and in one plane and lockable with a gate.

The gate is herein developed as a plate-form sliding gate, which, for the purpose of opening and closing the gate opening, is disposed parallel to the plane of the gate opening and slightly spaced apart from the gate opening. The gate is operatively connected with a driving rod and a drive on the side facing away from the gate opposite the gate opening. This gate is supported in the sliding direction and supported opposing the gate opening at a specified distance. The driving rod is connected with the gate via a guidance mechanism, such as for example a short lever, which can change or deflect the direction of the movement of the gate, such that in the presence of a blockage of the closing process through a hindrance and/or a limitation in the proximity of the gate opening, the gate is laterally pressed against a seal encompassing the gate opening in the vertical direction with respect to the plane of the gate opening. The driving rod is connected with the gate and/or the driving rod-side guidance mechanism with a spring element such that the spring narrowly compensates or bears the weight of the gate. In this way the gate is resiliently and movably disposed on the driving rod and can be slid with respect to the driving rod in the vertical direction about the spring path determined by the spring element.

The gate is consequently slid over the gate opening via a driving rod with a linear movement, for example driven via a pneumatic or hydraulic lifting piston or via an electro-motor linear drive. As soon as the plate-form gate, which as a rule is comprised of metal, has reached its end position and covers the gate opening, the translational movement of the gate is hindered by an end stop. This hindrance in the vertical direction triggers a further lateral movement toward the gate opening, which is generated through the guidance mechanism, such as for example through a lever mechanism. The gate is herein pressed onto the seal encompassing the gate opening and the vacuum chamber is consequently sealed against the atmosphere on the other side. Should during the closing of the gate an obstruction be located in the gate opening, such as for example an object or in particular a human body part, such as a hand, the gate is going to resiliently abut this object or this obstruction and, according to the present invention, upon attaining a maximally permissible closing force of 100 N is stopped through the present construction. This is attained thereby that the drive with the guidance mechanism and the spring configuration is dimensioned such that the gate is pressed against the seal and, due to the friction of the seal with the gate surface, the gate is braked and/or stopped immediately. As soon as an obstruction hinders the sliding movement of the gate, only the lateral movement in the direction toward the seal takes place and the pressing of the gate onto this seal. The entire mechanism is implemented such that the spring element can substantially absorb the weight of the gate and, if need be, certain frictional forces and, additionally, maximally a closing force of 100 N remains.

The spring element is implemented such that during the entire deflection process, thus over the entire path distance of the lateral pressing movement, a spring action is available. The spring action is consequently retained until the gate is pressed against the seal, is stopped and blocked.

Therewith it is ensured that with a hindrance of the closing process through a human body part, such as a hand, only the permissible, specified, resilient forces act onto this hindrance and injuries of the body part are reliably avoided.

The drive is laid out such that it can maximally generate said forces and upon reaching the sum of these forces blocks automatically. This ensures that, for example a human body part, such as a hand or an arm, is maximally loaded with 100 N, if these are carelessly extended into the closure opening. Consequently possibilities for injury are excluded with high certainty. In order to minimize these forces and injury risks further, additional electronic means can be employed, for example sensors for the permanent detection of the gate position or sensors for measuring the forces coupled with a corresponding movement control of the drive of the gate.

The guidance mechanism for deflecting the direction of the gate movement from the vertical direction into a, for example, horizontal or lateral direction can take place for example through a deflection gearing, a lever mechanism or via a ramp configuration. The lever mechanism and, in particular the ramp configuration, are herein preferred implementations, since these can be realized especially reliably and economically.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the following the invention will be explained in further detail by example and with reference to schematic figures. In the drawing depict:

FIG. 1a a vacuum chamber with a lock with the gate open with a guidance mechanism implemented as a lever mechanism,

FIG. 1b a vacuum chamber with lock gate at the end stop overlapping the lock opening,

FIG. 1c a vacuum chamber with lock gate overlapping the lock opening and pressed against the seal, whereby the lock is closed under a seal,

FIG. 2a the configuration corresponding to FIG. 1a in the open state, with a hindrance such as a hand being located in the opening of the lock,

FIG. 2b the lock configuration during the closing of the gate and abutting against the hindrance through the human hand,

FIG. 2c the lock configuration with the gate abutting against the hindrance, the gate being stopped through the automatic pressing against the seal via the lever mechanism,

FIG. 3a a further implementation of a lock with the guidance mechanism being implemented as a ramp configuration, in the open position corresponding to FIG. 1a,

FIG. 3b the configuration according to FIG. 3a with the lock gate in the end stop, and

FIG. 3c the configuration according to FIGS. 3a and 3b with the lock gate in the end stop and pressed against the gate opening and consequently in the closed state.

### DESCRIPTION OF THE PREFERRED EMBODIMENTS

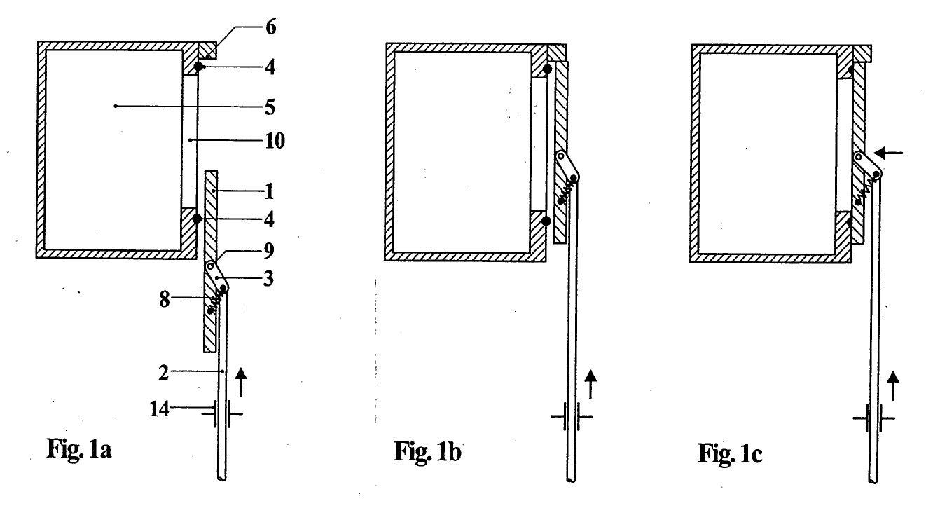

In the figures preferred embodiments of lock configurations according to the invention are depicted schematically and in section. FIG. 1a shows a lock chamber 5 with a sliding gate 1 in the open state. The chamber 5 comprises an opening 10, which with a seal 4 is disposed on the outer surface of the chamber 5 in order to be able to seal in the closed state the outer region of the chamber against the inner region. Vacuum chambers as well as also the associated lock gates in vacuum applications are, as a rule, comprised of metal such as aluminum or stainless steel. The gate 1 consists of a plate, which is supported such that it can be slid parallel to the plane of the gate opening 10 and be moved in any position in the lateral direction against the seal vertically with respect to the gate opening 10 and can, consequently, be pressed against the seal. The distance of the gate 1 with respect to the surface of the chamber wall or the gate opening 10 is conventionally a few millimeters, such that the gate during the parallel displacement does not touch the chamber wall or the seal 4. The configuration according to the invention relates to gates 1 to be moved substantially vertically.

The driving of the gate for the sliding movement takes place from below, wherewith the driving acts against the weight of the gate 1. The gate 1 is coupled via a driving rod 2. with a drive, such as for example a pneumatic, hydraulic or electric linear drive The driving rod 2 is journalled in a guide 14, such that this rod can be moved in a defined, preferably constant, distance from the gate opening 10, for the closing in the longitudinal direction, preferably parallel to the plane of the gate opening 10, in the longitudinal direction of the rod for closing and opening of the gate 1. It is understood that the driving rod 2 can also be implemented as a mechanical connection part which does not have the form of a rod.

In this process the gate 1 is located between the plane of the gate opening and the driving rod 2. The driving rod 2 is movably connected with the gate 1 via a pivot point 9 or a pivot axis 9 on the side of the gate 1 facing away from the gate opening via a guidance mechanism formed of a short lever 3. Beneath the pivot point 9 a spring element 8 is disposed on the gate 1 and connected under prestress with the driving side of lever 3 or preferably in the proximity of the driving rod 2 such that the spring element 8 at least bears the weight of the gate 1 and maintains the gate with respect to the lever 3 and the driving rod 2 in the upper position of the lever configuration. Thereby is achieved that the gate 1 opposite to the gate opening is slightly spaced apart, such as for example by a few millimeters, such that the gate 1 when being displaced across the gate opening 10 during normal operation does not contact it or the seal 4. When the gate 1 is displaced vertically it moves into the end position, representing the closing position, against a limitation 6, as is depicted in FIG. 1b. The closing drive now attempts with a force which is minimally above the gate weight and the frictional forces to push the gate further against the limitation 6. The lever 3 is moved under prestress through the spring element 8 such that the gate 1, vertically with respect to the gate opening, is laterally displaced and consequently is pressed against the gate opening 10 and the seal 4, as is shown in FIG. 1c. If the gate 1 abuts on a hindrance 7 or the limitation 6, via the guidance mechanism lateral deflection forces are generated when the gate 1 is pressed onto the seal 4, which are absorbed by the guide 14 of the driving rod 2.

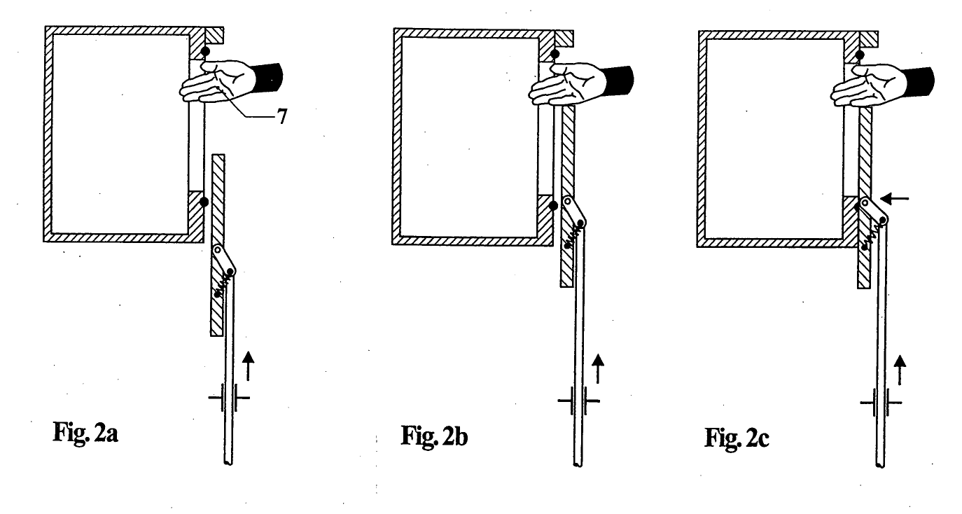

If, as depicted in FIG. 2a, a hindrance 7, in particular a hand 7, is introduced into the closure opening of the lock chamber, dangerous conditions, such as in particular injuries of the operator may occur during an unintentional closing of gate 1. In such a case the gate 1 is going to abut the hindrance 7, thus the hand, according to FIG. 2b during the closing and push against it.

According to the invention the lever mechanism 3 with the spring element 8 is laid out together with the drive such that the hindrance or the hand 7 can not be loaded with more than 100 N. The spring element 8 is thus laid out such that it can narrowly bear the weight of the gate 1 and the possible additional frictional forces, before the lever 3 commences action in the presence of a possible hindrance 7. Through the hindrance, as depicted in FIG. 2c, the gate 1 is pressed in the lateral direction onto the seal of the chamber wall, wherewith the occurring friction between seal and gate 1 acts additionally in a braking or stopping manner.

In the present examples a spring element 8 is depicted as a tension-loaded spring element. The configuration can also be realized with a spring element 8, which is compression loaded. In this case it is only necessary to reposition appropriately the fastening configuration between the driving rod 2 and the gate 1, such that again the weight of the gate is resiliently supported. The spring element 8 can be realized in various ways, such as for example as a flat spiral spring, plate spring, leaf spring, pneumatic spring or also as a rubber-elastic element.

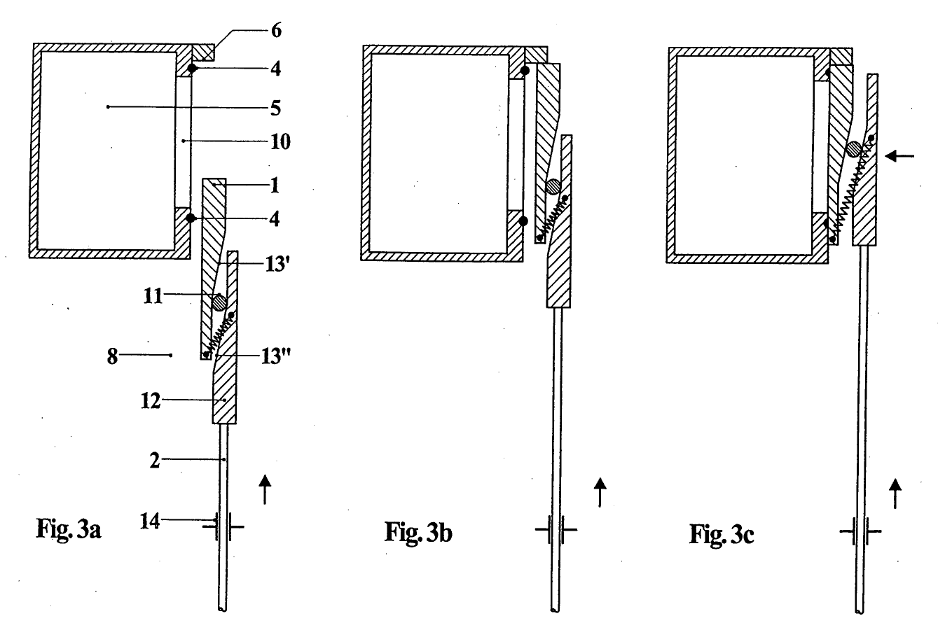

A further, especially preferred, embodiment is depicted schematically in FIG. 3. The guidance mechanism for the deflection of the direction of movement, as shown in FIG. 3a, is comprised of a first ramp 13′ vertically disposed on the backside of the gate and a second ramp 13′ disposed on the driving rod with roller element 11 disposed between the two ramps, which forms a type of bearing and rolls away between the ramps 13 when the spring loaded gate 1 through a hindrance 7 or the limitation 6 is displaced relative to the driving rod 2. In this displacement process, as depicted in FIGS. 3b and 3c, the forces are deflected laterally via the ramps 13 and the gate 1 is pressed against the gate opening 10, as has been described previously. The configuration can also be operated with one ramp 13′ or 13″ only, if the roller element is located on the one opposing side of a ramp as roller element 11 via an axle. In the case of this deflection mechanism realized via ramps different further mechanic implementations are also possible within the scope of the present invention.

Overall, through the appropriate dimensioning of the spring element configuration 8 together with the friction of the seal and the drive, it is necessary to ensure that no more than 100 N pressing capacity can act onto the hindrance 7. When dimensioning the driving power it is consequently also necessary to pay attention to the fact that in the dimensioning of the driving forces, these also do not exceed the corresponding forces on the driving side also and such force stops or runs to exhaustion. Further improvements and refinements are possible by utilizing additional electronic means, which measure the position of the gate and the actions of the drive and control them accordingly via the drive.

While a specific embodiment of the invention has been shown and described in detail to illustrate the application of the principles of the invention, it will be understood that the invention may be embodied otherwise without departing from such principles.

1. Vacuum lock disposed on a vacuum chamber (5) with a gate opening (10) lockable with a gate (1) disposed substantially vertically and in a plane with the following characteristics:
a) the gate (1) is implemented as a plate-form sliding gate, which, for opening and closing the gate opening (10), is displaceably disposed parallel to the plane of the gate opening (10) at a slight spacing with respect to the latter,
b) the gate (1) is operatively connected with a driving rod (2) with the gate (1) on the side facing away opposing the gate opening (1) and supported with respect to the gate opening (10) at a specified distance in the sliding direction, the driving rod (2) being connected with a drive,
c) the gate (1) is connected with the driving rod (2) via a guidance mechanism (3, 13′, 13″, 11) such that in the presence of a blockage of the closing process by a hindrance (7) and/or a limitation (6) in the proximity of the gate opening (10), the gate (1) is laterally pressed on a seal (4) encompassing the gate opening (10) in the vertical direction toward the plane of the gate opening (10),
d) the gate (1) is connected with the driving rod (2) and/or the driving rod-side guidance mechanism (3, 13′, 13″, 11) with a spring element (8) such that this spring narrowly compensates the weight of the gate (1).

2. Vacuum lock as claimed in claim 1, characterized in that the seal (4) upon contact with the surface of the gate (1) has a friction such that a damping element is formed for braking and/or stopping the gate movement and that therein substantially only a lateral movement takes place by compressing of the seal (4).

3. Vacuum lock as claimed in claim 1, characterized in that the drive and the spring element (8) absorbs a force which bears at least the weight of the gate and that the remaining driving force during the closing process of the gate (1) does not exceed 100 N.

4. Vacuum lock as claimed in claim 3, characterized in that the lock configuration comprises additional electronic means for acquiring the position of the gate (1) and/or for the movement control.

5. Vacuum lock as claimed in claim 1, characterized in that the guidance mechanism (3, 13′, 13″, 11) comprises a lever (3) which movably connects the gate (1) and the driving rod (2).

6. Vacuum lock as claimed in claim 1, characterized in that the guidance mechanism (3, 13′, 13″, 11) includes at least one ramp (13) and this ramp is disposed on the gate (1) or on the driving rod (2) and a roller element (11) is disposed so as to roll away on the ramp (13) such that when the gate (1) is resiliently displaced with respect to the driving rod (2) this gate is laterally pressed onto the gate opening (10).

7. Vacuum lock as claimed in claim 1, characterized in that the lock configuration is implemented as a safety device for the protection of the personnel.

8. Method for transferring substrates through a lock into a vacuum chamber (5) with a gate opening (10) disposed substantially vertically and in a plane and lockable with a gate (1), with the following characteristics:
a) the gate (1) is implemented as a plate-form sliding gate, which, for opening and closing the gate opening (10), is displaceably disposed parallel to the plane of the gate opening (10) and at a slight spacing from it, b) the gate (1) is operatively connected with a driving rod (2) with the gate (1) on the side facing away opposing the gate opening (1) and supported with respect to the gate opening (10) at
a specified distance in the sliding direction, the driving rod (2) being connected with a drive,
c) the gate (1) is connected with the driving rod (2) via a short lever (3) such that in the presence of a blockage of the closing process through a hindrance (7) and/or a limitation (6) in the proximity of the gate opening (10) the gate (1) is laterally pressed in the vertical direction to the plane of the gate opening (10) onto a seal (4) encompassing the gate opening (10),
d) the gate (1) is connected with the driving rod (2) and/or the driving rod-side lever (3) with a spring element (8) such that this spring narrowly compensates the weight of the gate (1) during the closing.

9. Method as claimed in claim 8, characterized in that the friction, generated upon the contact of the seal (4) with the surface of the gate (1), forms a damping element for braking and/or stopping the gate movement and that herein substantially only a lateral movement takes place by compressing the seal (4).

10. Method as claimed in claim 8, characterized in that the drive and the spring element (8) absorb a force, which bears at least the weight of the gate and that the remaining driving force does not exceed 100 N during the closing process of the gate (1).

11. Method as claimed in claim 10, characterized in that with additional electronic means the position of the gate (1) is acquired and/or the motion sequence is controlled with a motion control of the gate (1) for the purpose of controlling the force action.

12. Method as claimed in claim 8, characterized in that the guidance mechanism (3, 13′, 13″, 11) comprises a lever (3), which movably connects the gate (1) and the driving rod (2).

13. Method as claimed in claim 8, characterized in that the guidance mechanism (3, 13′, 13″, 11) is operated with at least one ramp (13) and this ramp is disposed on the gate (1) or on the driving rod (2) and a roller element (11) is disposed rolling off the ramp (13) such that when the gate (1) is slid resiliently with respect to the driving rod (2), this gate is laterally pressed onto the gate opening (10).

14. Method as claimed in claim 8, characterized in that the lock configuration is employed as a safety device for the protection of personnel.
